(19) United States
(12) Patent Application Publication
(10) Pub. No.: US 2019/0135160 A1
(43) Pub. Date: May 9, 2019

(54) FIXTURE ASSEMBLY

(71) Applicant: Composite Advanced Technologies CNG, LLC, Houston, TX (US)

(72) Inventor: Ryan Joseph REINECK, Bullard, TX (US)

(21) Appl. No.: 16/103,682

(22) Filed: Aug. 14, 2018

Related U.S. Application Data
(60) Provisional application No. 62/581,554, filed on Nov. 3, 2017.

(51) Int. Cl. B60P 3/22

(52) U.S. Cl. CPC B60P 3/2215; B60P 3/221

(57) ABSTRACT

A method and apparatus for a mounting system for an elongate tank includes a pivoting fixture for retaining a first end of the tank, the fixture pivotable about an axis perpendicular to a longitudinal axis of the tank; and a translating fixture permitting axial movement of the tank in a direction parallel to the longitudinal axis of the tank.

### CROSS-REFERENCE TO RELATED APPLICATIONS

This application claims benefit of U.S. provisional patent application Ser. No. 62/581,554, filed Nov. 3, 2017, which is herein incorporated by reference.

### BACKGROUND

### Field

Embodiments described herein generally relate to a mounting system for an elongate tank.

### SUMMARY

The present disclosure generally includes a method and apparatus for a mounting system for an elongate tank. In one embodiment, the invention includes a pivoting fixture for retaining a first end of the tank, the fixture pivotable about an axis perpendicular to a longitudinal axis of the tank and a translating fixture permitting axial movement of the tank in a direction parallel to the longitudinal axis of the tank.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a partial side view of a trailer showing two tanks mounted thereon.

FIG. 2 is a perspective view of a pivoting fixture for use in securing a tank to the trailer.

FIG. 3 is a side view of the pivoting fixture of FIG. 2 showing the range of pivot about a pivot axis.

FIG. 4 is a side view of the pivoting fixture showing installation of the fixture around a boss disposed on a first end of a tank.

FIG. 5 is front view of the pivoting fixture with the boss of the tank installed therein.

FIG. 6 is a side view in section showing the boss in the pivoting fixture and showing details of the boss and tank.

FIG. 7 is a perspective view of a translating fixture for retaining a boss at an opposite end of the tank.

FIG. 8 is a side view of the translating fixture showing a pivoting function available during installation of the boss in the fixture for minor adjustments to the angle of the upper and lower pillow blocks relative to a foot of the fixture.

FIG. 9 is a side view of the translating fixture showing installation of the fixture around a boss disposed on a second end of the tank.

FIG. 10 is a front view of the translation fixture with a boss of the tank installed therein.

FIG. 11 is a side view in section showing the boss in the translating fixture and showing the tank in a retracted position relative to the fixture.

FIG. 12 is a side view in section showing the boss in the translating fixture and showing the tank in an extended position relative to the fixture.

FIG. 13 is a front view of an alternative embodiment of a pivoting fixture.

FIG. 14 is a top view of the fixture of FIG. 13.

### DETAILED DESCRIPTION

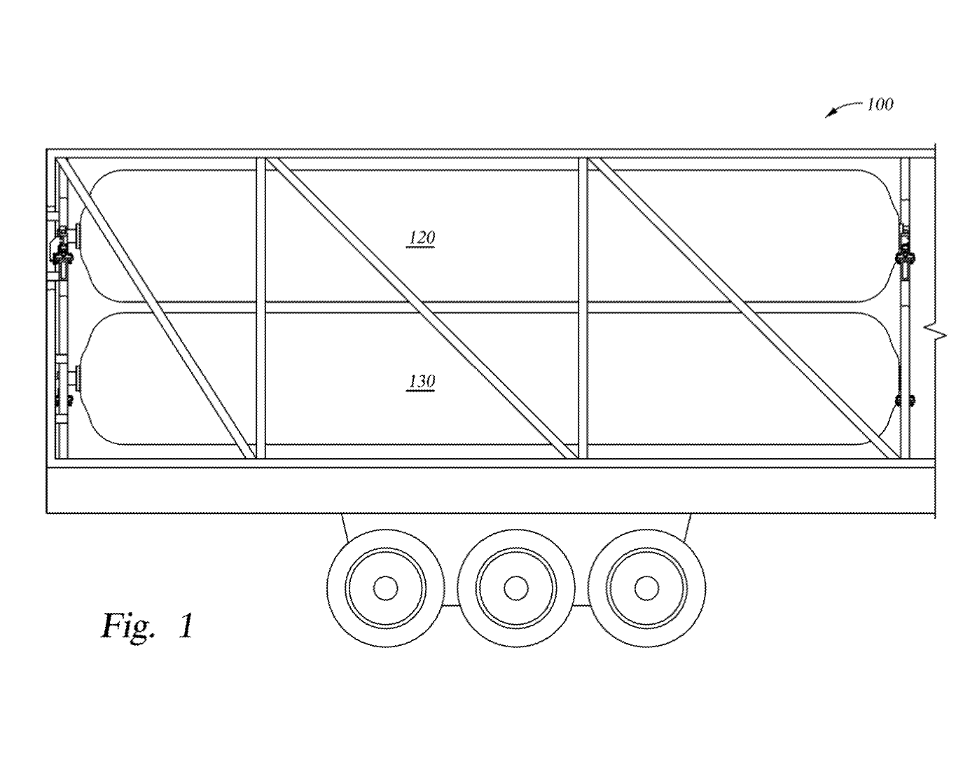

FIG. 1 is a partial side view of a trailer 100 for transporting tanks. An upper 120 and a lower 130 tank are shown. In one embodiment, eight tanks are arranged on the trailer in two groups of four. In one embodiment, the tanks are used for transporting compressed gas, like CNG. In one embodiment, the tanks are constructed of a flexible plastic core/liner and are then wrapped to give them an outer layer of matrix material whereby they are capable of holding gas pressurized to over 4,000 psi at room temperature. The arrangement contemplated involves filling, transporting, and emptying the tanks while they remain on the trailer 100. Each tank 120, 130 has a filling means at one end and a manifold (not shown) that permits control of the introduction and unloading of gas from a single location on the trailer.

Due to the length of the tanks, the high pressure gas therein and environmental and road conditions, the tanks must be securely mounted on the trailer. However, the mounting arrangement must also compensate for dimensional changes in the tanks brought about by pressure and temperature. Additionally, mounting must permit certain shifting of the tanks as they move due to movements and deflection of the trailer along a roadway. The tanks are equipped with a metallic, cylindrical boss at each end and each boss interacts with a fixture that secures it to the trailer but provides for certain movement of the tank within the fixture.

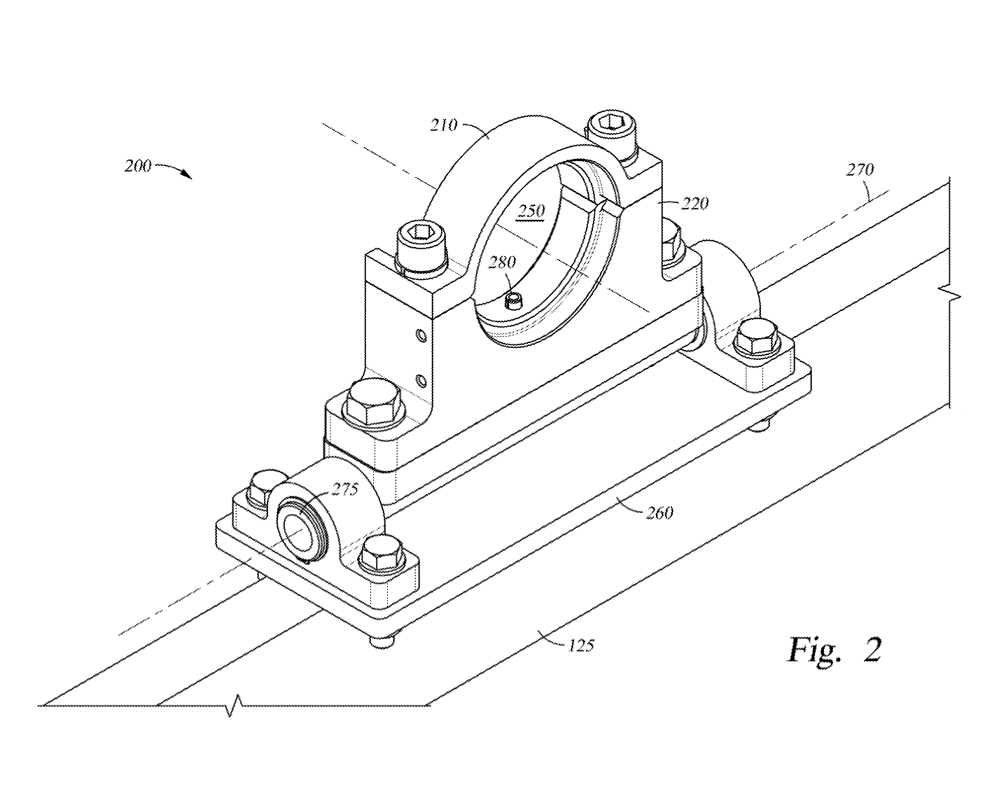

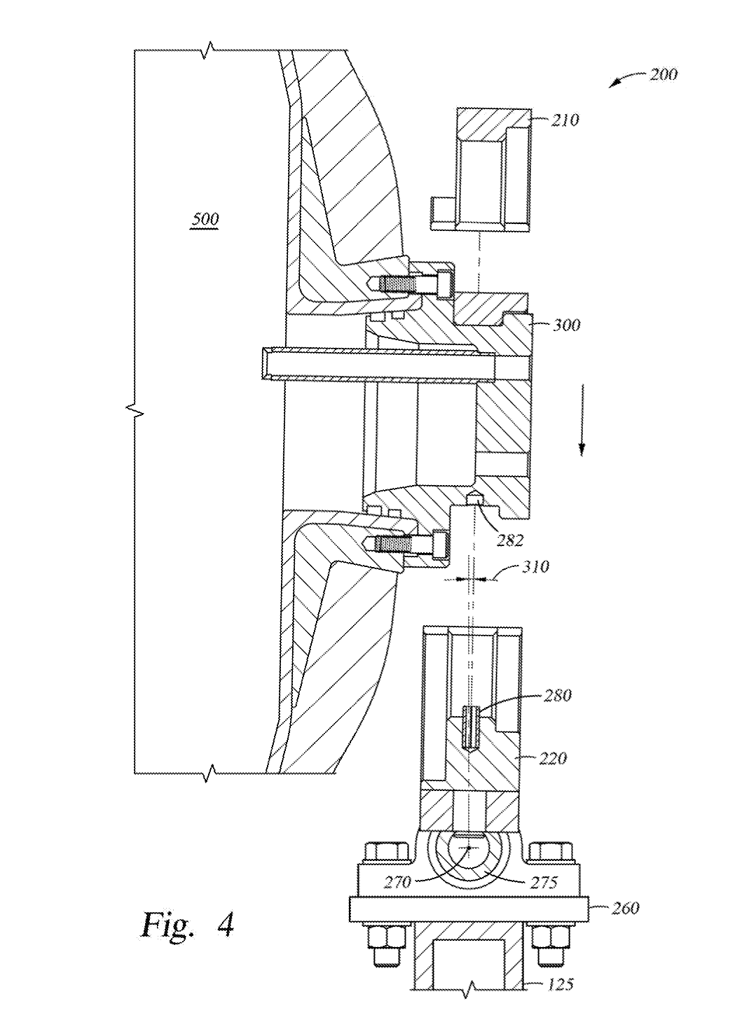

FIG. 2 is a perspective view of a pivoting fixture 200 for interaction with a first end of the tank (not shown). The fixture includes an upper 210 and lower 220 pillow block with an aperture 250 formed therein to hold the boss of the tank. The pillow blocks are pivotally connected to a part of the trailer frame 260 that is in turn connected to a beam 125. As will be explained herein, the first end of the tank is lowered, typically by crane, at an angle whereby the boss is cradled in the bottom pillow block 220 of the fixture 200. The fixture is constructed and arranged to permit the pillow blocks to pivot about a pivot axis 270 provided by a pivot axle 275. The pivoting feature permits the boss to be placed in the lower block and the upper block to be installed while an opposite end of the tank remains elevated. When the fixture is assembled, the boss is held in the aperture 250 created between the upper and lower pillow block members. In addition to the pivot function that permits the tank some movement when installed in the pivoting fixture, the fixture includes an anti-rotation feature in the form of an anti-rotation pin 280 extending into the aperture 250 from the lower pillow block 220. A corresponding anti-rotation aperture 282 is formed in an outer wall of the boss as can be seen in FIG. 4. The pin 280 and aperture 282 arrangement prevent rotation of the tank along its axis but also ensure the tank is rotationally fixed in a location that permits the alignment of a number of connections that facilitate filling and emptying of the tank.

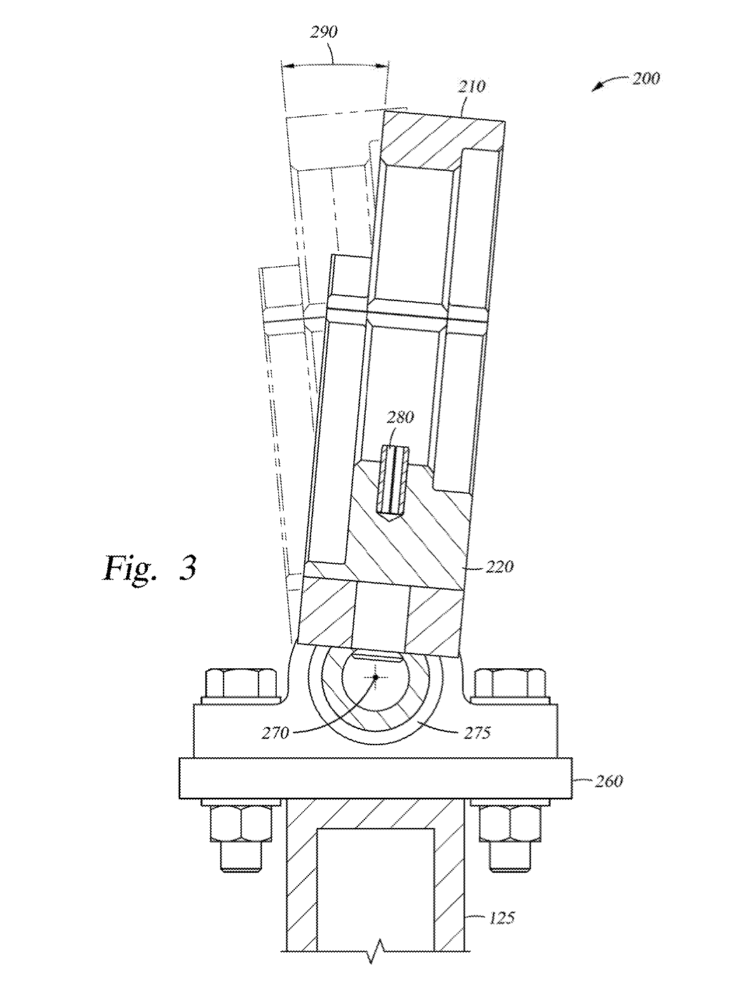

FIG. 3 is a side view of the pivoting fixture and illustrates a range of motion 290 provided by the pivoting feature as well as the pivot axle 275 and the center line of pivot between the pillow blocks and a foot of the fixture. In the Figure, the fixture 200 is shown in its pivoted position that would be typically used as the boss of an angled tank is lowered into the fixture. FIG. 3 illustrates the upper 210 and lower 220 pillow blocks assembled together but does not show the boss.

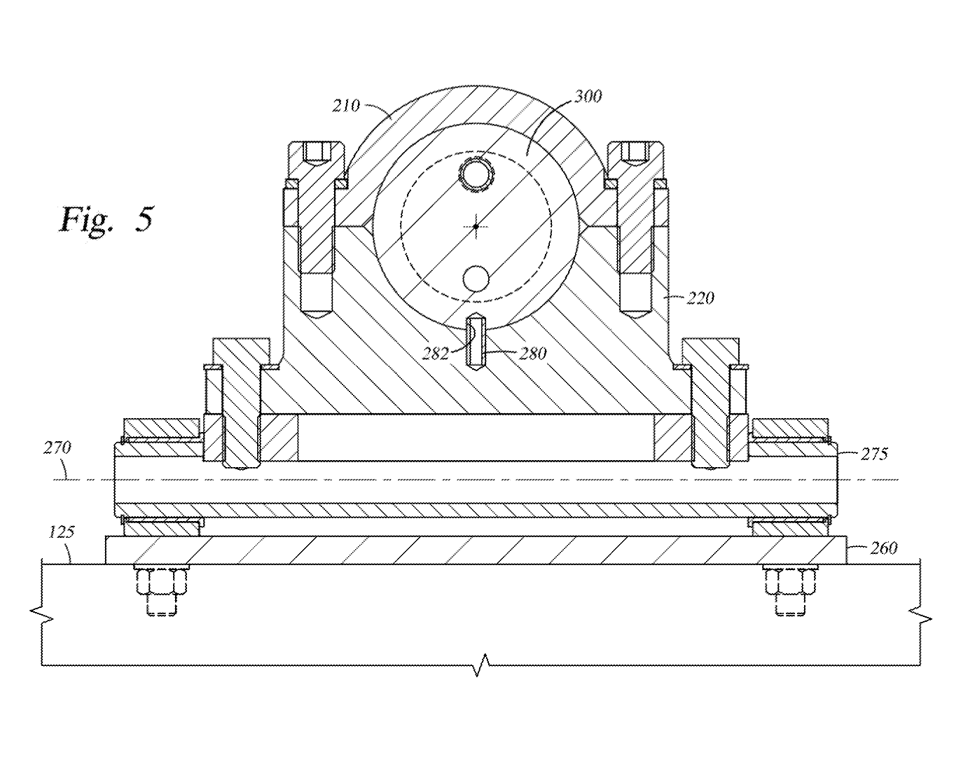

FIG. 4 is a side view of the pivoting fixture 200 showing installation of the fixture around a boss 300 disposed on a first end of a tank 500. Arrows specifically illustrate how the lower pillow block 220 can be pivoted to align the anti-rotation pin 280 with its mating aperture 282 in the boss 300. Once the alignment is made and the boss 300 is seated in the lower pillow block 220, the upper portion 210 can be installed and the assembly tightened. FIG. 5 is a front view of the pivoting fixture 200 with the upper 210 and lower 220 pillow blocks assembled and the boss 300 of the tank 500 held therein. As shown, the anti-rotation pin 280 of the lower pillow block is installed in the mating aperture 282 of the boss, thereby rotationally fixing the tank 500 at a certain location and preventing additional rotation about the axis of the tank. The fixture 200 and the boss 300 remain free to pivot as needed about pivot axis 270.

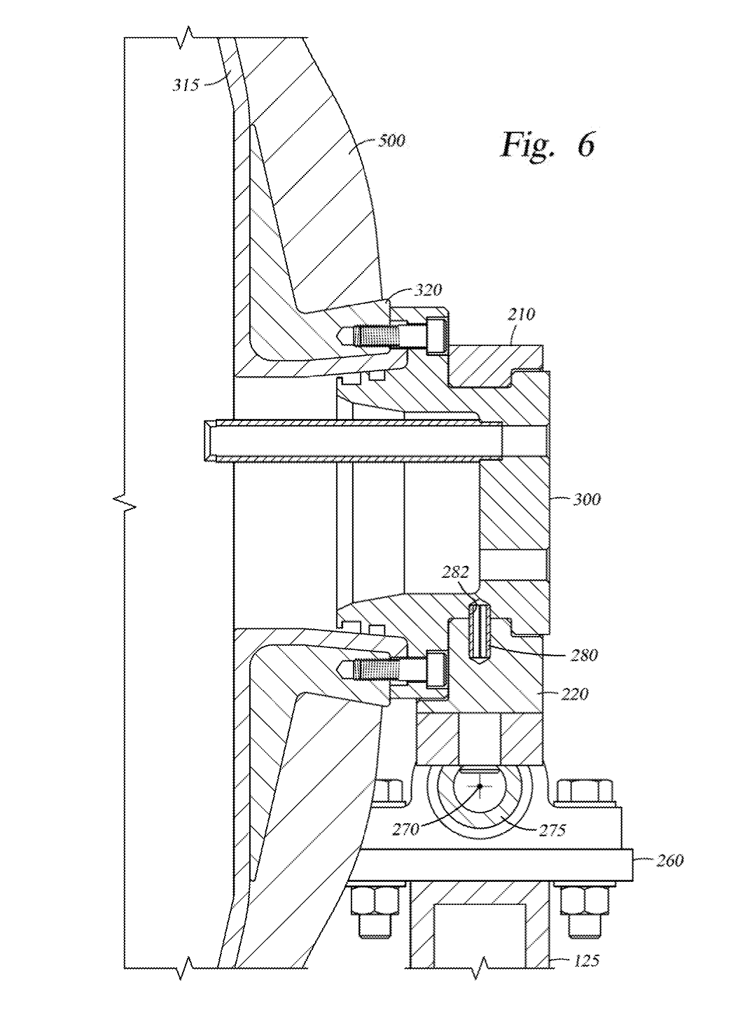

FIG. 6 is a cross section side view of the boss 300 of the tank 500 installed in the pivoting fixture 200. The Figure illustrates the portions of the assembly previously described, including the upper 210 and lower 220 pillow blocks, pin 280 and aperture 282 to prevent rotation as well as an interior wall 315 of the tank 500, a reinforcement member 320 to which the boss 300 is secured, and the outer shell of the tank 500. In one embodiment, the liner is formed to the inner diameter of the reinforcement member 320 and the tank is thereafter wrapped with carbon fiber before the boss is bolted and sealed against the liner. Flanges between the boss 300 and the pillow block members 210, 220 prevent the boss from axially translating within the pivoting fixture 200.

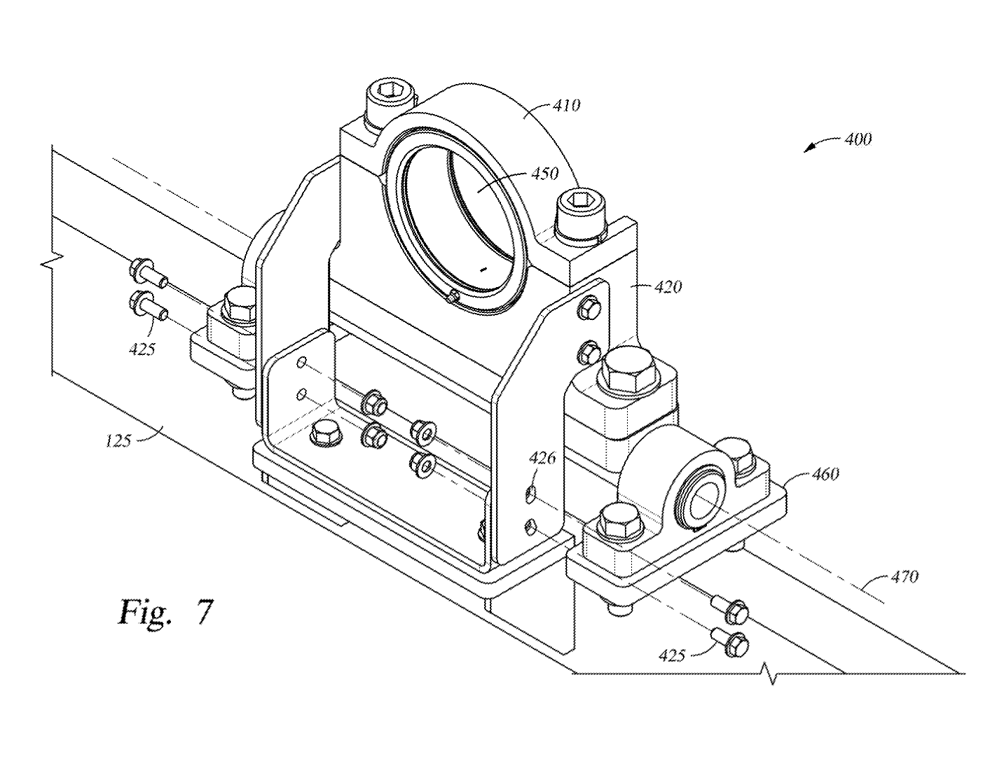

FIG. 7 is a perspective view of a translating fixture 400 for retaining a boss (not shown) at an opposite end of the tank 500. Like the pivoting fixture 200, the translating fixture includes upper 410 and lower 420 pillow blocks that are connected to form an aperture 450 therein for retaining the boss. Unlike the pivoting fixture 200, wherein axial translation is prevented by opposing flanges, the translating fixture 400 is intended to permit elongation and shrinkage of the tank in length as it is filled, emptied, and as the compressed gas inside reacts to environmental changes, like temperature. Additionally, the fixture 400 permits limited pivoting during installation for adjustments to the pivot angle of the pillow blocks in relation to the base of the fixture. As illustrated, a plurality of fasteners 425 are provided to prevent pivotal movement of the pillow blocks when tightened. However, the apertures 426 for receiving the fasteners are slot-shaped, thereby permitting some pivotal adjustment of the pillow blocks 410, 420 about a pivot axis 470. The slot-shaped apertures are utilized during installation of the tank 500 to compensate for a tank that for any reason is not completely straight between its two ends. In one instance the tank, due to its length and construction, sags somewhat in the center, resulting in one end being somewhat angled upwards. The adjustment feature is especially useful in these instances.

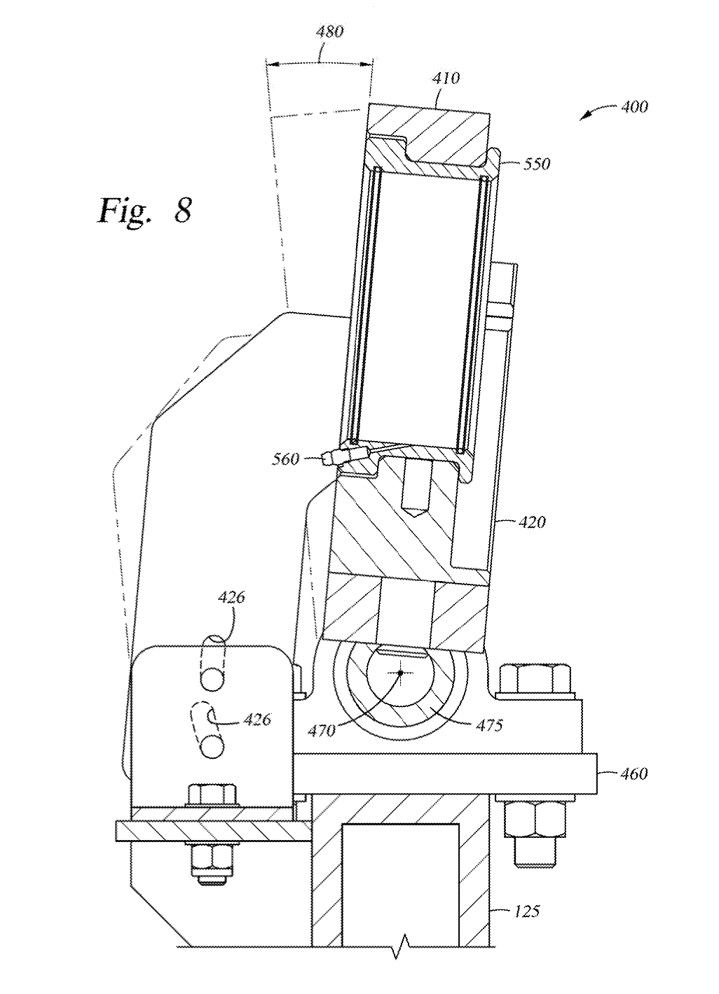

FIG. 8 is a side view of the translating fixture 400 showing the temporary pivoting function and range of motion 490 available during installation of a boss in the fixture. The slot-shaped apertures permitting the pivot adjustment are visible. Also shown in the figure is a feature permitting axial translation of a boss at the second end of the tank 500. The translation is facilitated by a translation bearing 550 that is typically formed of bronze and essentially lines the aperture 450 formed by the upper 410 and lower 420 pillow blocks. An annular area formed between the bearing 500 and the boss (not shown) is supplied with a lubricant from a lubricating source 560.

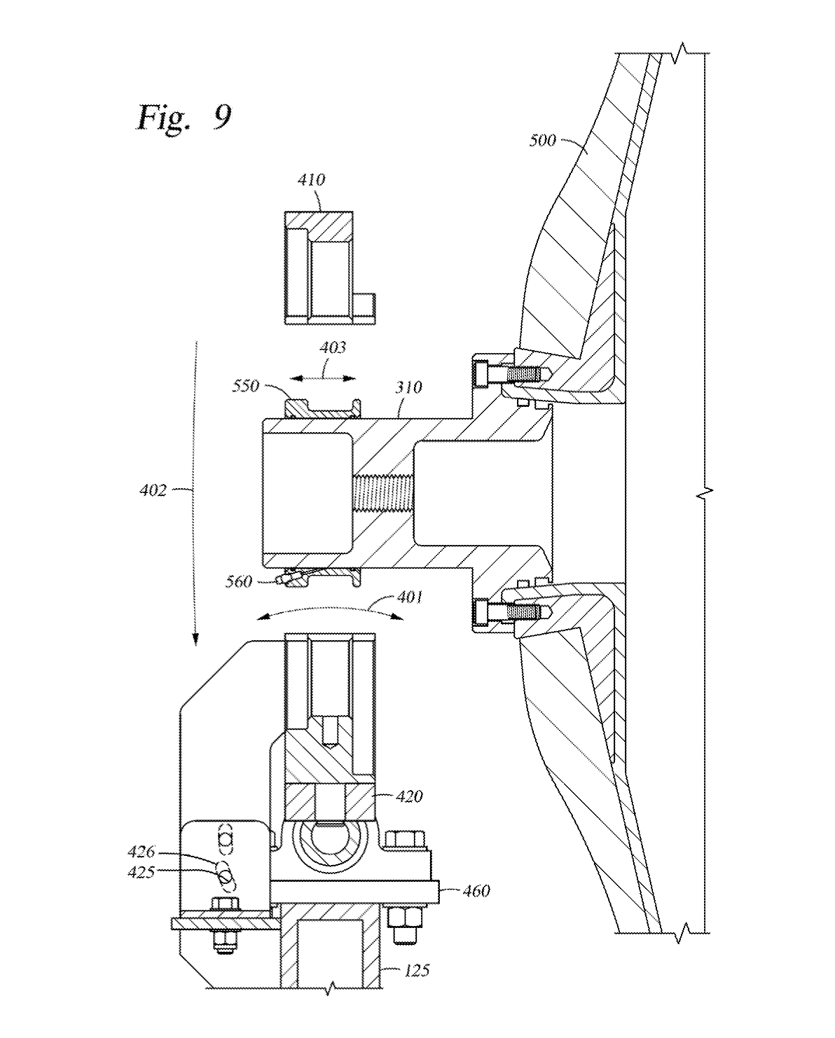

FIG. 9 is a side view of the translating fixture 400 showing installation of the fixture around a boss 310 disposed on a second end of the tank. The figure illustrates two typical adjustments 401, 403 possible as a second end of the tank 500 with its second boss 310 is installed in the fixture. Arrow 401 illustrates the pivoting function that is possible due to the slotted apertures of the fasteners that will permit the lower pillow block 420 to be pivoted slightly to align with the boss 310 which, as previously explained might be somewhat angled and will move in a slight arc as shown by arrow 402. Additionally, as shown by arrow 403, the translation bearing 550 is adjustable along the outer surface of the boss 310 as needed to be housed in the annular space created between the inside surface of the pillow blocks 410, 420 and the outer surface of the boss 310.

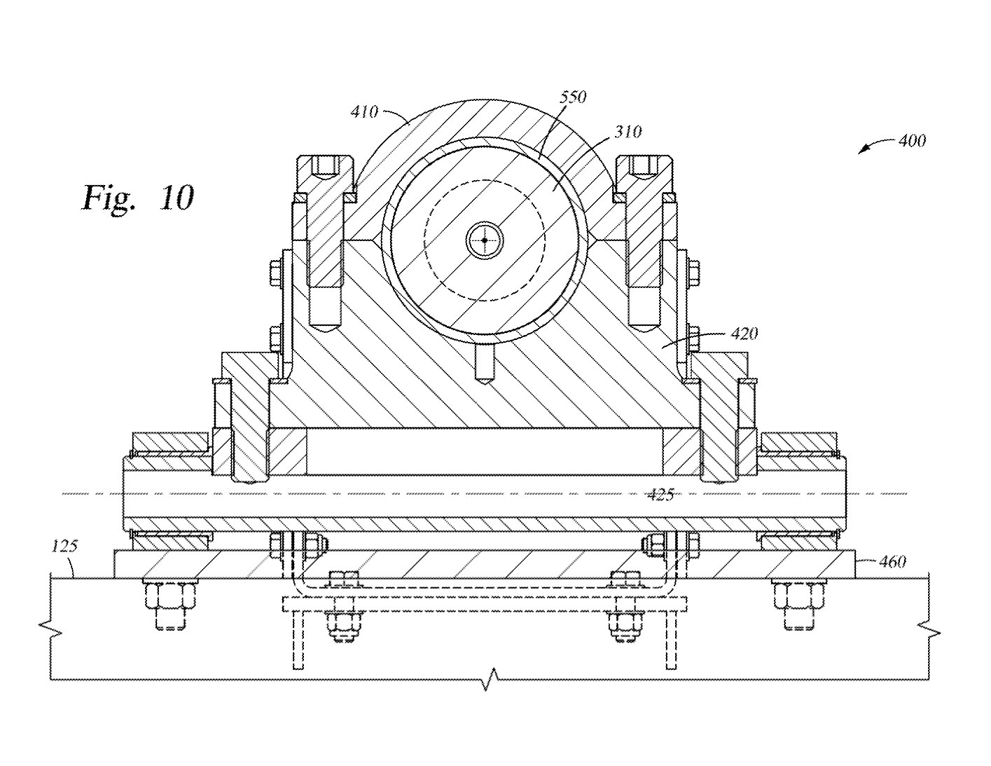

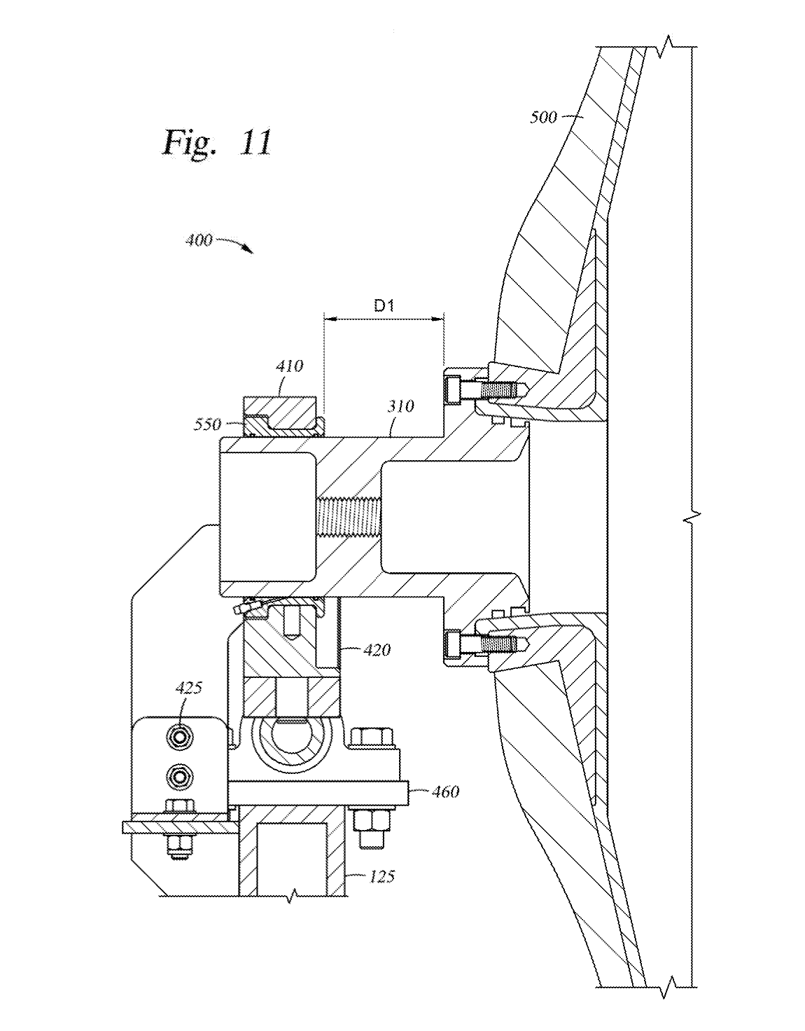

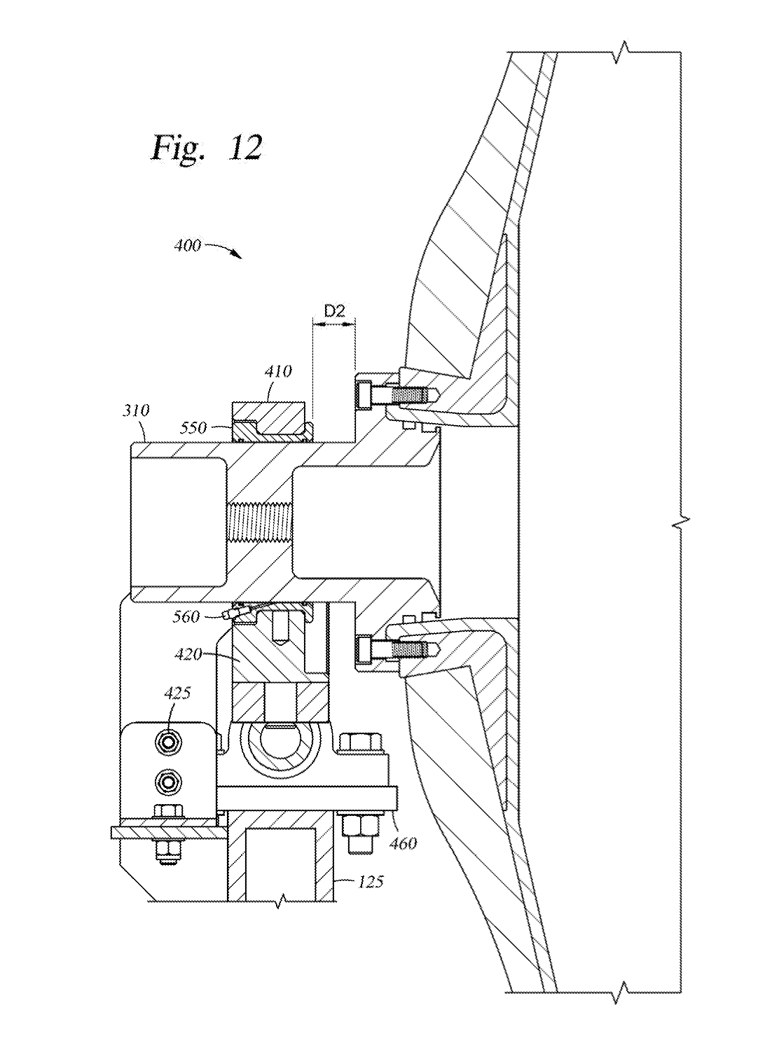

FIG. 10 is a front view of the translation fixture 400 with a boss 310 of the second end of the tank 500 installed therein. Visible in the Figure are the upper 410 and lower 420 pillow blocks that surround the boss 310 at the second end of the tank 500. The translation bearing 550 is visible in an annular area between the pillow blocks and the boss. Additionally, the fasteners 425 have been tightened in their slot-shaped apertures, thereby preventing additional pivoting of the pillow blocks. FIG. 11 is a side view in section showing the boss 310 in the translating fixture 400 and showing the boss 310 in a relatively retracted position in the fixture 400. The position is illustrated by dimension D1. FIG. 12 is a side view in section showing the boss in the translating fixture and showing the tank in a relatively extended position in the fixture 400. The position is illustrated by dimension D2. By comparison, dimension D2 in FIG. 12 is substantially smaller than dimension D1 in FIG. 11.

In an alternative embodiment, a wider translation bearing could be utilized to minimize the likelihood of binding between the bearing and the pillow blocks. In that instance, the entire fixture could be allowed to pivot permanently like the pivoting fixture described in relation to a first end of the tank.

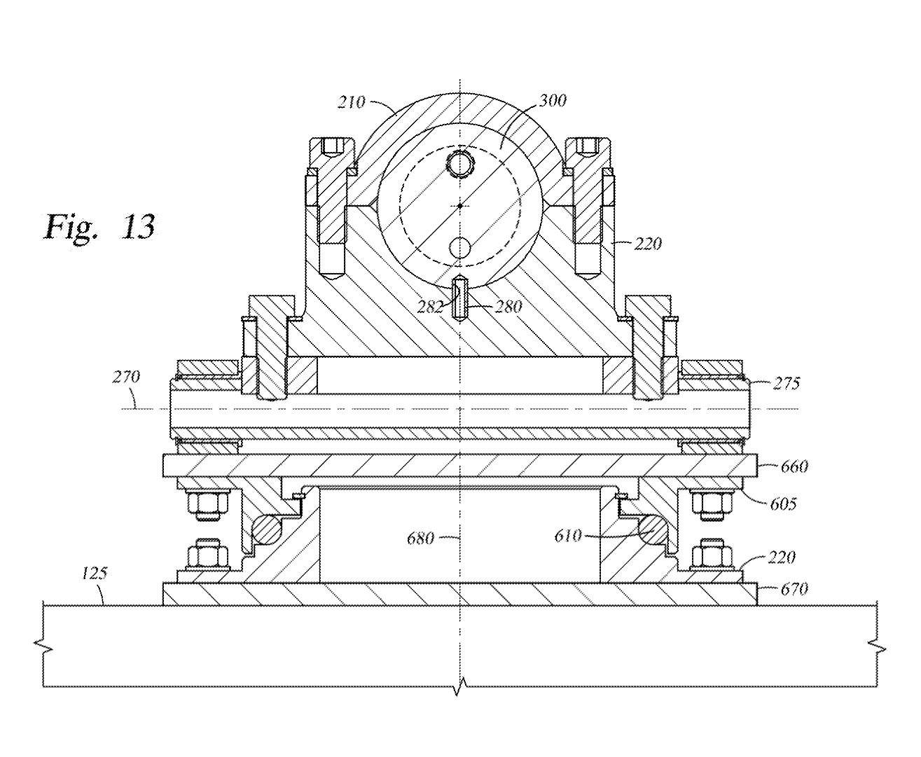

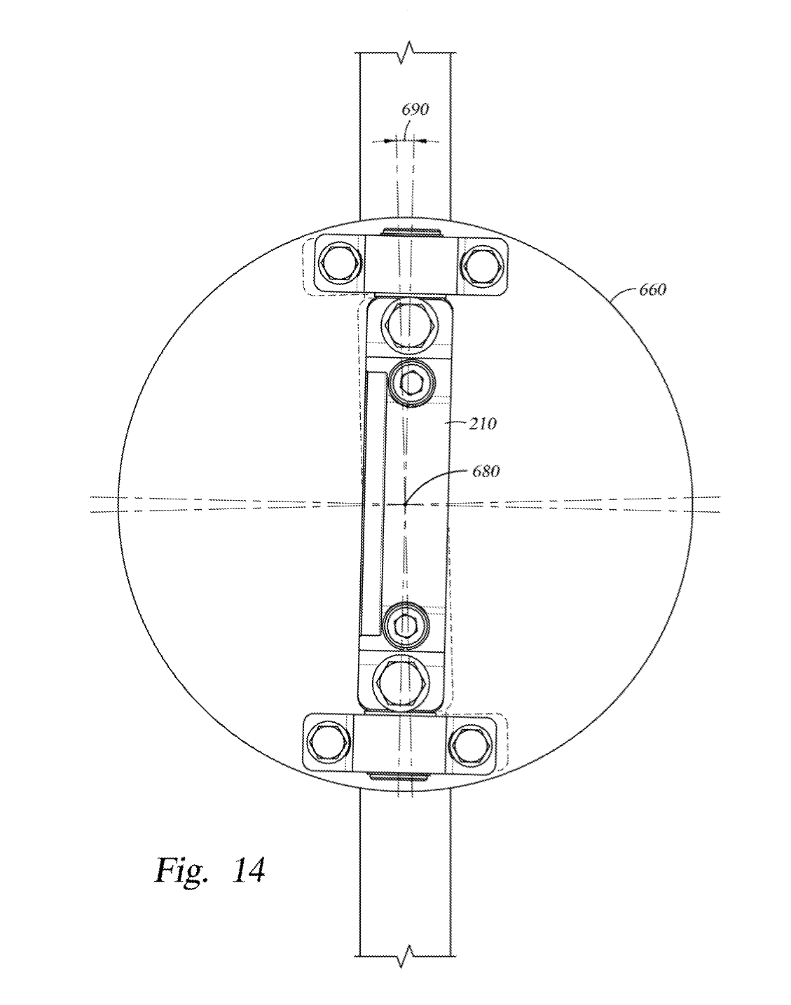

In a further embodiment, the bolts attaching the translating fixture to the trailer frame could themselves be supplied with slot-shaped apertures, thereby permitting adjustment/pivoting of the fixture from side to side during installation. In another embodiment, pivoting from side to side could be accomplished by utilizing a vertically oriented axle, like axle 275 presently utilized for pivoting about a horizontal axis. In this manner, pivoting about a vertical axis could compensate for movement of the trailer during transportation and such a feature could be used with one or both of the fixtures 200, 400. Such arrangements are fully within the scope of the invention. For example, FIG. 13 is a front view of a pivoting fixture that provides pivoting along a vertical as well as a horizontal axis. In addition to the features of the fixture explained in relation to FIGS. 2-6, the fixture includes a bearing and race arrangement comprising an upper race plate 605, a lower race plate 270, and a plurality of ball bearings 610 constructed and arranged to permit rotation of the assembly about a vertical axis 680. The result is a fixture that permits vertical and horizontal pivot-like rotation of the fixture as needed at any time during the process of handling and transporting the tank. In an alternative arrangement, either or both of the rotational features could be locked-out if needed. FIG. 14 is a top view of the fixture of FIG. 13 illustrating a range of movement 690 permitted by the bearing and race arrangement about center pivot point 680.

As illustrated and described herein, the invention provides a novel apparatus and method for mounting and retaining elongate tanks in a manner whereby movement of the tanks due to their content, their transportation and environmental conditions can be managed and compensated for in a manner ensuring safe and efficient transportation. In one embodiment, shown in FIG. 1, the trailer holding the tanks is minimally reinforced and the tanks themselves provide strength to the trailer, thus increasing the load capacity.

In one embodiment, a tank is installed and retained as follows: A first end of an elongate tank is lowered into a saddle formed by a lower pillow block of a pivoting fixture. The fixture is pivotable about a pivot axis to facilitate receipt of a boss extending from the first end. Once a second end of the tank has been lowered, an upper pillow block is installed on the pivoting fixture and the boss is retained in an aperture formed therein. An anti-rotation pin and aperture prevent rotation of the boss and with it the tank about the tank axis. The pivoting feature retains intact after installation to compensate for movement of the tank necessitated by being transported on a roadway.

A boss at a second end of the tank is received by a translating fixture having a similarly shaped lower pillow block. The lower pillow block is initially pivotable about its own pivot axle to facilitate installation. Once the tank is installed and the upper pillow block is in place, fasteners are secured to disable the pivoting feature. However, slotted apertures receiving the fasteners permit minor adjustments to the position of the pillow blocks to compensate for a final position of the second end. After installation, a translation bearing housed between an aperture formed by the pillow blocks and the boss, permits the boss to translate axially within the fixture to compensate for retraction and lengthening of the tank while being filled, emptied or while being transported.

In one embodiment, eight tanks are installed on a single trailer, each having its own pivoting and translating fixtures. Once installed, each tank is filed with, in one embodiment compressed natural gas via a manifold. After transportation, the tanks are unloaded using the same manifold without ever being physically unloaded or removed from their corresponding fixtures.

While the foregoing is directed to embodiments of the present disclosure, other and further embodiments of the disclosure may be devised without departing from the basic scope thereof, and the scope thereof is determined by the claims that follow.

1. A mounting system for an elongate tank, comprising:
a pivoting fixture for retaining a first end of the tank, the fixture pivotable about an axis perpendicular to a longitudinal axis of the tank and;
a translating fixture permitting axial movement of the tank in a direction parallel to the longitudinal axis of the tank.

2. The mounting system of claim 1, wherein the pivoting fixture also prevents rotation of the tank about its longitudinal axis.

3. The mounting system of claim 2, wherein rotation is prevented due to a pin and aperture arrangement between the tank and the pivoting fixture.

4. The mounting system of claim 3, wherein each end of the tank includes a boss, each boss held by one of the pivoting and translating fixtures.

5. The mounting system of claim 4, wherein each fixture includes an upper and a lower pillow block, the pillow blocks when assembled forming an aperture for receiving one of said bosses.

6. The mounting system of claim 5, wherein the aperture associated with the translating fixture includes a translation bearing disposed between an inner diameter of the aperture and an outer diameter of the boss.

7. The mounting system of claim 6, wherein the translating fixture initially includes a pivoting function wherein the fixture is pivotable about an axis perpendicular to a longitudinal axis of the tank.

8. The mounting system of claim 7, wherein after installation of the tank in the fixture, the pivoting function is disabled.

9. The mounting system of claim 1, wherein the fixtures are mounted on a vehicle trailer and the elongate tank is installed therebetween.

10. A method of mounting an elongate tank on a trailer, comprising:
providing a pivoting fixture for retaining a first end of the tank, the fixture pivotable about an axis perpendicular to a longitudinal axis of the tank;
placing a first end of the tank in a lower pillow block of the pivoting fixture and thereafter, installing an upper pillow block to form an aperture surrounding a boss formed at the first end of the tank;
providing a translating fixture for retaining a second end of the tank, the translating fixture permitting axial movement of the tank in a direction parallel to the longitudinal axis of the tank; and
placing a second end of the tank in a lower pillow block of the translating fixture and thereafter, installing an upper pillow block to form an aperture surrounding a boss formed at the second end of the tank.

11. The method of claim 10, wherein the translating fixture includes a pivoting feature that is disabled after installation of the tank.

12. The method of claim 11, wherein the pivoting fixture further fixes the first end in a predetermined rotational position relative to the fixture.

13. The method of claim 12, wherein a second tank is installed on the trailer using a second pivoting fixture and a second translating fixture.
